(19) United States
(12) Patent Application Publication
(10) Pub. No.: US 2006/0053308 A1
(43) Pub. Date: Mar. 9, 2006

(54) Secured redundant memory subsystem

(75) Inventor: Israel Zimmerman, Ashdod (IL)

Correspondence Address: Martin Moynihan;c/o ANTHONY CASTORINA, SUITE 207, 2001 JEFFERSON DAVIS HIGHWAY, ARLINGTON, VA, 22202, US

(73) Assignee: Raidy 2 Go Ltd.

(21) Appl. No.: 10/935,634

(22) Filed: Sep. 8, 2004

(51) Int. Cl. H04K 1/06; G06F 12/14; H04K 1/04; H04L 9/32; G06F 11/30

(52) U.S. Cl. 713/193; 380/37

(57) ABSTRACT

A storage device consists of multiple solid state memory devices and a memory controller. The memory devices are configured as a redundant array, such as a RAID memory array. The memory controller performs data encryption to provide secured access to the array. The encryption may be performed with an encryption data sequence which is stored on a separate memory element.

### FIELD AND BACKGROUND OF THE INVENTION

The present embodiments relate to a redundant memory subsystem with secured data access and, more particularly, to an encrypted memory subsystem based on a redundant array of solid state memories.

In today's market there is a large demand for fast, high capacity memory devices. In the consumer market, in particular, portable electronic devices such as digital cameras, wireless phones, and personal digital assistants (PDA) require memories that are both physically small and have low power requirements.

One approach to providing high-capacity fast and reliable memories is to combine several smaller capacity memories to function as a single device. RAID (Redundant Array of Independent Disks) is a method of accessing multiple individual disks as if the array were one larger disk, by spreading data over these multiple disks. The RAID acronym was first used in a 1988 paper by Berkeley researchers Patterson, Gibson and Katz, which described array configuration and applications for multiple inexpensive hard disks, providing fault tolerance (redundancy) and improved access rates.

There are a number of defined RAID levels, which utilize a variety of techniques to provide a memory system with higher performance than the component memory devices forming the array. FIGS. 1a to 1d illustrate four of these levels.

FIG. 1a shows the RAID 0 technique, which is also known as disk striping. Data is written in blocks across multiple drives, so that one drive can write or read a block while the next seeks the next block. The advantages of striping are a higher access rate and full utilization of the array capacity. The disadvantage is that there is no fault tolerance. If one drive fails, the entire contents of the array become inaccessible.

FIG. 1b shows the RAID 1 technique, which is also known as disk mirroring. Disk mirroring provides redundancy by writing data multiple times, to separate drives. If one drive fails, the other contains an exact duplicate of the data and the RAID can switch to a mirror drive with no lapse in user accessibility. The disadvantages of mirroring are no improvement in data access speed, and higher cost, since twice the number of drives are required. However, RAID 1 provides improved data protection if a member disk fails. The array management software can simply direct all application requests to the surviving disk members.

FIG. 1c illustrates a RAID 3 memory. RAID level 3 stripes data across multiple drives, with an additional drive dedicated to parity, for error correction/recovery.

FIG. 1d illustrates a RAID 5 memory, which is the most popular configuration, providing striping as well as parity for error recovery. In RAID 5, the parity block is distributed among the memory drives, giving a more balanced access load. The parity information is used to recover data if one drive fails. The disadvantage is a relatively slow write cycle (two reads and two writes are required for each block written).

Typically RAID is used in large file and application servers, where data accessibility is critical and fault tolerance is required. Nowadays, RAID arrays are being formed from smaller memory devices. RAID memories are increasingly being used in desktop systems for CAD, multimedia editing and playback where higher transfer rates are needed.

Another rapidly developing aspect of memory technology are solid state memories such as flash memories, in particular SFF flash memories. Flash memory is a widely used solid state electrically erasable programmable read-only memory (EEPROM) that can be erased and reprogrammed in blocks instead of one byte at a time. Flash memory is often used applications that store the firmware inside the device, such as in personal computer basic input/output system (BIOS), and is also popular in modems because it enables the modem manufacturer to support new protocols as they become standardized. Flash memory is smaller and lighter than magnetic disk drives, but has comparatively slow data access, low capacity, and is more expensive per megabyte.

A large number of flash memory devices are now available in the consumer market. Many of these devices are categorized as SFF devices, and have the advantages of small size and low power requirements. Examples of SFF flash memories include CompactFlash® (CF™), Secure Digital (SD), XD, USB Disk on Key and Multi Media Card (MMC).

As an example, CF™ is a very small solid state removable mass storage device. First introduced in 1994 by SanDisk Corporation, CF™ cards weigh half an ounce and are the size of a matchbook. They provide complete PCMCIA-ATA functionality and compatibility plus TrueIDE functionality compatible with ATA/ATAPI-4. At 43 mm (1.7″)×36 nm (1.4″)×3.3 mm (0.13″), the device's thickness is less than one-half of a current PCMCIA Type II card and one-fourth the volume of a PCMCIA card. CF™ cards are generally more rugged and reliable than disk drives including those found in PC Card Type III products, and consume five percent of the power required by small disk drives. CF™ cards come in two standard sizes. CF™ Type I (CFI) cards are 3.3 mm thick, while CF™ Type II (CFII) cards which 5.0 mm thick, which are shown in FIGS. 2a and 2b respectively.

SFF memory devices, in particular flash memories, are attractive for use in portable electronic equipment due to their advanced data interfacing capabilities and low power requirements. They are widely supported by numerous platforms and operation systems. Because of their compatibility with Parallel ATA (IDE-ATAPI), these media are expected to have a longer life than other data storage media available today.

Although smaller RAID memories are becoming available, current RAID systems are still not appropriate for portable devices, due to their large size and weight. An additional problem with current RAID memories is that while they provide increased data integrity and reliability, the stored data is not protected against unauthorized access. Since in the past RAID memories were largely for stationary, large scale memories, data security was directed to preventing unauthorized access via the data interface. Installing these memories in portable devices introduces an additional threat, which is that the device will fall into other hands. The stored data must therefore be protected against other types of access, by someone in physical possession of the device.

In U.S. Pat. No. 5,680,579 Young et al. disclose a memory device employing a redundant array of solid state memory devices is presented, which combines RAID technology architecture with solid state memory devices. In Young's device a plurality of circuit boards assemblies are electrically connected to solid state memory devices (for example, flash memory PCMCIA cards). The assemblies are mounted within a housing, preferably a housing which fits into a standard 5¼ inch computer drive bay or a rack mount housing. A data path controller circuit provides the interface between a host system and the flash memory cards. Young's memory utilizes a redundant memory configuration, but does not provide data security. Data can be easily accessed via the data connection. Additionally, the present embodiments are of a relatively large memory which is not suitable for small handheld equipment, such as a digital camera or cell phone, and do not possess advanced data interfaces such as serial ATA (SATA), USB and Firewire.

In U.S. Pat. application 20040158711, Vincent Zimmer discloses RAID configuration manager which provides an operating system with a content of a virtual disk interface to enable a commensurate software RAID to be utilized after the operating system is loaded. The operating system performs a number of functions such as loading a driver to abstract a plurality of disk interfaces for a plurality of disks, publishing a physical access abstraction interface and a device path protocol for each disk, and other functions. An encrypted file system manager is also included to layer an encoded File Allocation Table on top of a disk and to pass to the operating system an Embedded Root Key to provide access to an encrypted Firmware Interface System Partition. However, no encryption is performed on the data stored in the RAID memory. Unencrypted data can therefore be read directly from the memory, and possibly reconstructed, without decrypting the FAT. Thus the stored data remains vulnerable.

There is thus a widely recognized need for, and it would be highly advantageous to have, a redundant memory subsystem with secured data access devoid of the above limitations.

### SUMMARY OF THE INVENTION

According to a first aspect of the present invention there is provided a storage device containing multiple solid state memory devices, which are configured as a redundant array, and a memory controller associated with the memory array. The memory controller performs data encryption to provide secured access to the array. Preferably, the controller consists of a field programmable gate array (FGPA).

Preferably, the controller contains an encryption element for encrypting data with an encryption data sequence stored on a memory element external to the array.

In the preferred embodiment, and encryption data sequence is provided externally.

Preferably, the controller contains an encryption generator which generates an encryption data sequence.

Preferably, the encryption is performed upon sector access.

In the preferred embodiment, encryption preferably consists of XORing the data with the encryption data sequence in accordance with a predefined mapping. The mapping is preferably cyclic.

In the preferred embodiment, each of the memory devices is subdivided into multiple sectors, the encryption data sequence is grouped into multiple blocks, and the encryption element contains an encryption mapper and a data encrypter. The encryption mapper maps each of the sectors to one of the blocks. Preferably, the mapping is cyclic. The data encrypter encrypts the data from a specified sector with a corresponding mapped block of the encryption data sequence. Preferably, the size of a block and the size of a sector are essentially equal. Encryption preferably consists of XORing the data associated with the sector specified for encryption with the corresponding mapped block of the encryption data sequence.

Preferably, the encryption element also contains a data decrypter, which decrypts stored data from a specified sector with a corresponding mapped block of the encryption data sequence. Decryption preferably consists of XORing the data associated with the sector specified for decryption with the corresponding mapped block of the encryption data sequence.

Preferably, the controller contains an encryption data memory for storing the encryption data sequence. The encryption data memory is preferably a flash memory.

Preferably, the controller erases the encryption data sequence upon occurrence of a trigger event. Preferably, the trigger event consists of receiving an external trigger signal and/or receiving an incorrect password for data access. Other trigger events are possible.

In the preferred embodiment, the memory devices are flash memories, preferably SFF flash memories. Preferably, the memory devices consist of one of a group of devices including: CompactFlash (CF™), Multimedia Card (MMC), Secure Digital (SD), Memory stick, Smart Media, and xD Picture Card.

Preferably, the memory devices are small form factor memories.

Preferably, the redundancy is in accordance with a Redundant Array of Independent Disks (RAID) standard.

Preferably, the controller is operable to perform one or more of the following functions: data striping, disk mirroring, providing parity information, error correction, and data caching. Preferably, the parity information is stored on a single memory device or distributed across more than one memory device.

Preferably, the storage device further contains a data interface for inputting data and outputting data. The data interface preferably is of one of the following interface types: an Advanced Technology Attachment (ATA) interface, a serial ATA (SATA) interface, a Universal Serial Bus (USB) interface, an IEEE 1394 interface, a small computer system interface (SCSI), or an Ethernet interface.

Preferably, the controller contains a control interface for inputting and outputting control data. In the preferred embodiment, the control data is used for performing at least one of the following group: programming the controller, inputting an encryption data sequence, inputting encryption data sequence parameters, outputting an encryption data sequence, inputting a password, upgrading software, diagnostic testing, selecting a redundancy method, establishing system definitions, and formatting the memory array.

According to a second aspect of the present invention there is provided a data securer for securing stored data. The data securer consists of an encryption data memory, for storing an encryption data sequence, and a data encrypter, for encrypting data stored in a separate memory element using the encryption data sequence.

Preferably, the memory element is external.

Preferably, the data securer further contains a data storage unit for storing encrypted data.

Preferably, the data storage unit is a RAID memory.

Preferably, encryption consists of XORing stored data with the encryption data sequence in accordance with a predefined mapping.

Preferably, the data securer further contains a data decrypter for decrypting stored data using the encryption data sequence.

Preferably, decryption consists of XORing stored data with the encryption data sequence in accordance with a predefined mapping.

Preferably, the data securer further contains a controller for managing data security.

Preferably, the controller is operable to erase the encryption data sequence upon occurrence of a trigger event.

Preferably, the trigger event consists of receipt of an external trigger signal.

Preferably, the encryption data sequence is provided externally.

Preferably, the controller contains an encryption generator for generating the encryption data sequence.

Preferably, the encryption data memory is a flash memory.

According to a third aspect of the present invention there is provided a data securer, for securing data with an encryption data sequence. The data is stored in a memory element subdivided into multiple sectors, and the encryption data sequence being grouped into multiple blocks. The data securer consists of an encryption mapper, for mapping each of the sectors to one of the blocks, and a data encrypter, for encrypting data associated with a first specified sector with a corresponding mapped block of the encryption data sequence.

Preferably, the size of a block and the size of a sector are essentially equal.

Preferably, the data securer further contains a data decrypter for decrypting stored data from a second specified sector with a corresponding mapped block of the encryption data sequence.

Preferably, encryption consists of XORing the associated data with the corresponding mapped block of the encryption data sequence.

Preferably, decryption consists of XORing data stored in the second specified sector with the corresponding block of the encryption data sequence.

Preferably, the data securer further contains an encryption data memory for storing the encryption data sequence.

According to a fourth aspect of the present invention there is provided a method for securing stored data. The method consists of the following steps. First, multiple solid state memory devices are configured as a redundant array. Then, data for storage on the array is encrypted with an encryption data sequence stored on a memory element external to the array.

Preferably, the method contains the further step of storing the encrypted data in the array.

Preferably, each of the memory devices is subdivided into multiple sectors, and encryption consists of: subdividing the encryption data sequence into multiple blocks, mapping each of the sectors to a corresponding one of the blocks, and encrypting data associated with a first specified sector with the corresponding mapped block of the encryption data sequence.

Preferably, the size of a block and the size of a sector are essentially equal.

Preferably, encryption consists of XORing the associated data with the corresponding mapped block of the encryption data sequence.

Preferably, the method contains the further step of decrypting data stored in a second specified sector with a corresponding mapped block of the encryption data sequence.

Preferably, the method contains the further step of outputting the decrypted data.

Preferably, decryption consists of XORing data stored in the sector with the corresponding mapped block of the encryption data sequence.

Preferably, the method contains the further step of inputting the encryption data sequence.

Preferably, the method contains the further step of storing the encryption data sequence in an encryption sequence memory.

Preferably, the method contains the further step of erasing the encryption data sequence upon occurrence of a trigger event.

Preferably, the redundancy is in accordance with a Redundant Array of Independent Disks (RAID) standard.

According to a fifth aspect of the present invention there is provided a method for securing stored data, consisting of: storing an encryption data sequence in an encryption data memory, and encrypting data associated with a separate memory device using the encryption data sequence.

Preferably, the memory element is subdivided into multiple sectors, and encryption consists of: subdividing the encryption data sequence into multiple blocks, mapping each of the sectors to a corresponding block, and encrypting data associated with a first specified sector with the corresponding block of the encryption data sequence.

Preferably, the size of a block and the size of a sector are essentially equal.

Preferably, encryption is performed by XORing stored data with the encryption data sequence in accordance with a predefined mapping.

Preferably, the method contains the further step of decrypting data stored in a second specified sector with a corresponding mapped block of the encryption data sequence.

Preferably the method contains the further step of erasing the encryption data sequence upon occurrence of a trigger event.

Preferably the method contains the further step of generating the encryption data sequence.

Preferably the method contains the further step of generating the mapping.

According to a sixth aspect of the present invention there is provided a method for securing stored data. The data is stored in a memory element, which is subdivided into multiple sectors. The method consists of: providing an encryption data sequence, subdividing the encryption data sequence into multiple blocks whose size essentially equals the size of a sector, mapping each of the sectors to a corresponding one of the blocks, and encrypting data associated with a first specified sector with the corresponding block of the encryption data sequence.

Preferably, encryption is performed by XORing the associated data with the corresponding block of the encryption data sequence.

Preferably, the method contains the further step of decrypting stored data from a second specified sector with a corresponding block of the encryption data sequence. Preferably, decryption is performed by XORing data stored in the second specified sector with the corresponding block of the encryption data sequence.

The present invention successfully addresses the shortcomings of the presently known configurations by providing a redundant memory subsystem with secured data access.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1a to 1d illustrate RAID levels 0, 1, 3 and 5 respectively.

FIGS. 2a and 2b respectively show a CF™ Type I card (CFI) and a CF™ Type II (CFII) card.

FIG. 3 is a simplified block diagram of a storage device, according to a preferred embodiment of the present invention.

FIG. 4 is a simplified block diagram of an encryption element, according to a preferred embodiment of the present invention.

FIG. 5 shows an example of a mapping between memory sectors and encryption sequence blocks.

FIG. 6 illustrates an example of a hardware configuration which can contain four CF™ type 2 cards along with a controller.

FIG. 7 is a simplified block diagram of a data securer, according to a first preferred embodiment of the present invention.

FIG. 8 is a simplified block diagram of a data securer, according to a second preferred embodiment of the present invention.

FIG. 9 is a simplified flowchart of a method for securing stored data, according to a first preferred embodiment of the present invention.

FIG. 10 is a simplified flowchart of a method for encrypting data with an encryption data sequence, according to a preferred embodiment of the present invention.

FIG. 11 is a simplified flowchart of a method for securing stored data, according to a second preferred embodiment of the present invention.

FIG. 12 is a simplified flow chart of a method for encrypting data that involves encrypting data in sectors in correspondence with encryption data blocks, according to a preferred embodiment of the present invention.

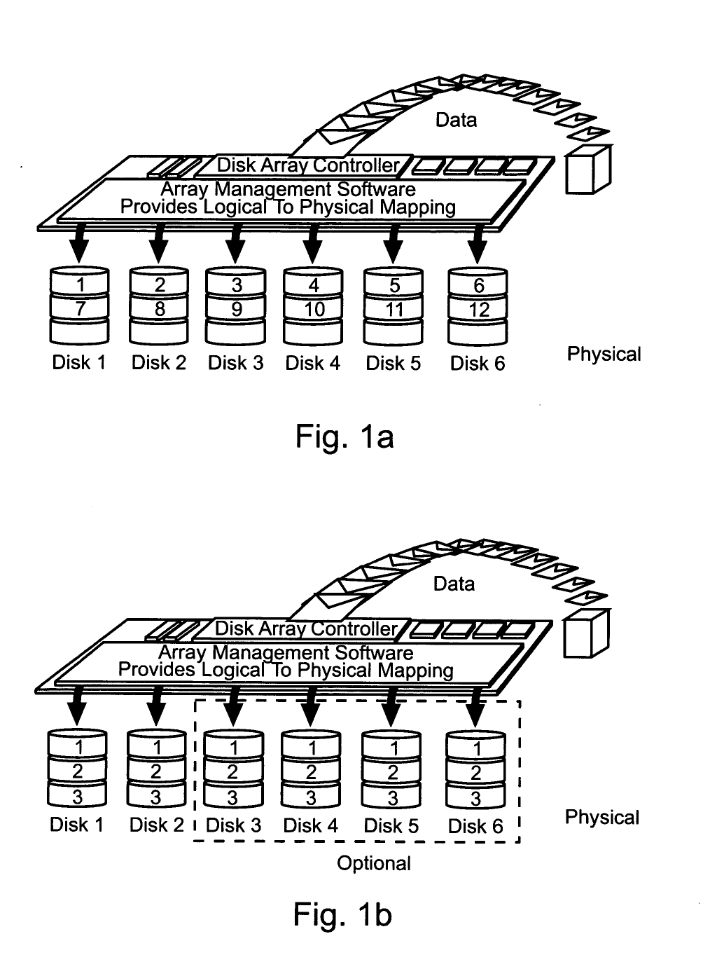

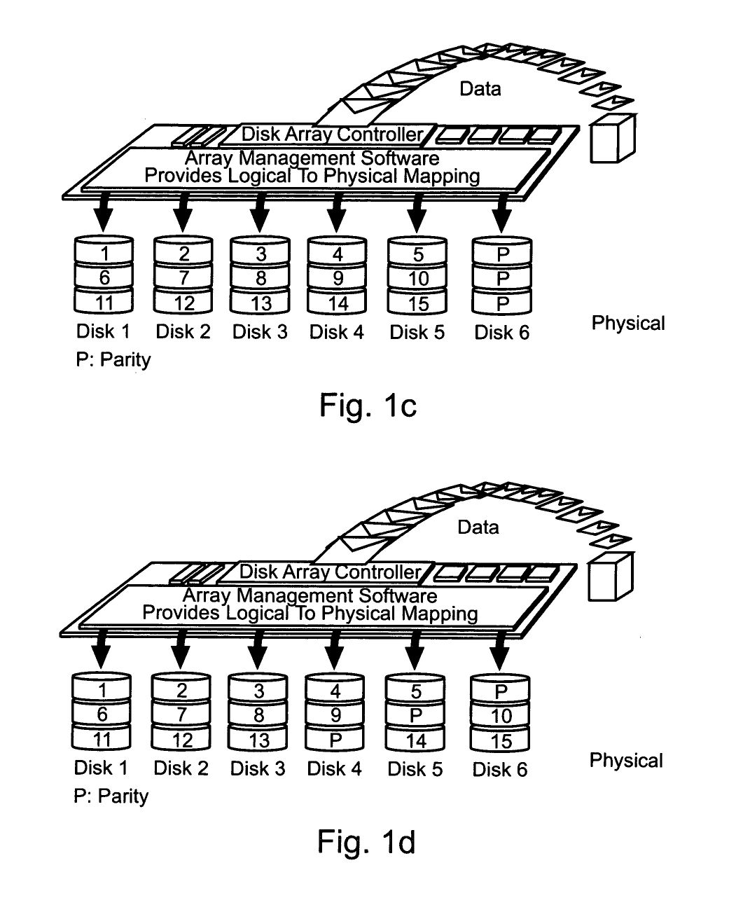

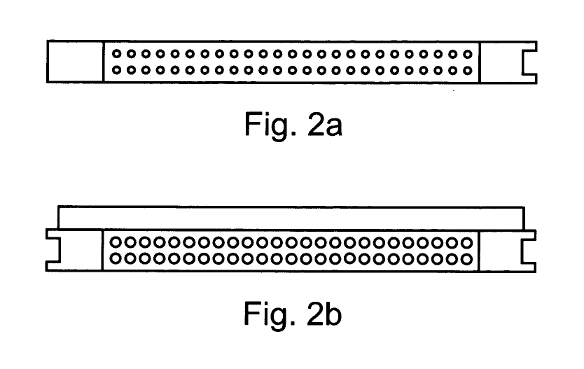

### DESCRIPTION OF THE PREFERRED EMBODIMENTS

The present embodiments are of a redundant memory subsystem which performs data encryption, in order to secure stored data against unauthorized access.

Many portable devices currently exist in both civilian and military use. These portable devices often carry sensitive data, which the user does not wish to be accessible if the device is lost or stolen. The data security problems that arise when securing sensitive data in portable devices are different than those encountered with stationary devices. In stationary devices an unauthorized accessor is unlikely to have physical access to the device, so that the main security problem is data access via the data connection. Security devices such as firewalls guard against hackers and other intruders from the data network. However, the data security problem is exacerbated in portable devices, which may fall into the wrong hands, so that access is available to the device hardware as well.

Specifically, the present embodiments can be used to create high capacity memories for storage of sensitive user data on portable devices.

The principles and operation of a secured redundant memory subsystem according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

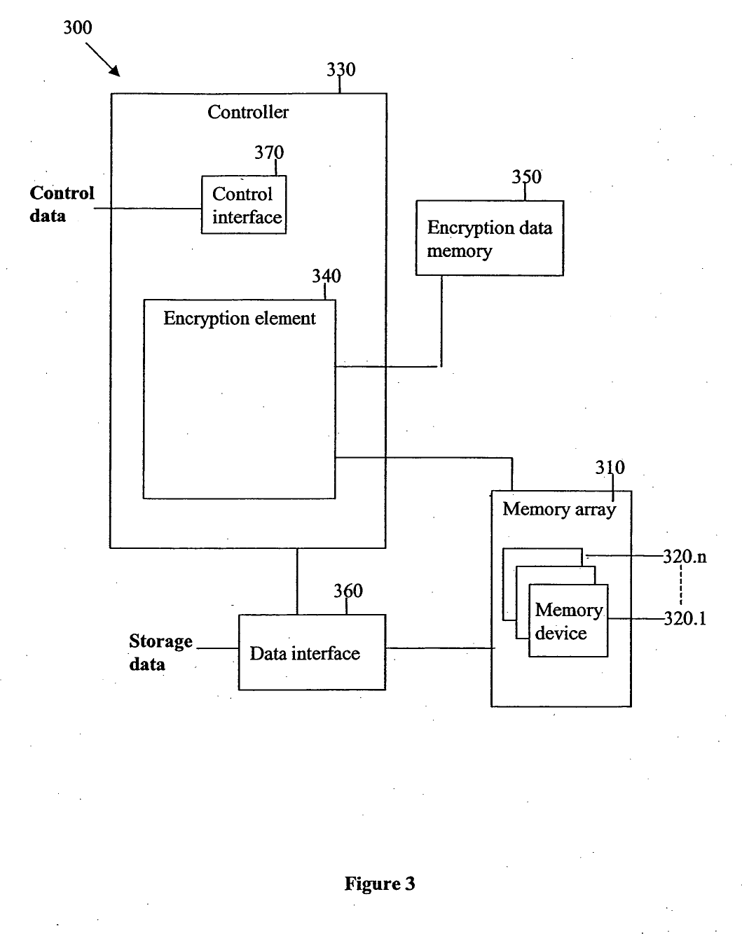

Reference is now made to FIG. 3, which is a simplified block diagram of a storage device, according to a preferred embodiment of the present invention. Storage device 300 consists of memory array 310, which is made up of two or more memory devices 320.1 to 320.n, and memory controller 330. Memory controller 330 provides secured access to memory array 310, where memory array 310 is accessed and controlled as a redundant array. Secured data access is provided by performing data encryption as described below. Controller 330 is preferably a field programmable gate array (FGPA).

In the preferred embodiment, memory devices 320.1 to 320.n are solid state memories, preferably flash memories. In a further preferred embodiment, the memory devices are small form factor (SFF) memories, particularly SFF flash memories. Currently available SFF flash memories encompass a number of devices including: CF™, Multimedia Card (MMC), Secure Digital (SD), Memory stick, USB Disk on Key, Smart Media, and xD Picture Card. Using SFF flash memories for the memory array yields a compact storage device 300, with low power requirements and high capacity. Memory technology is constantly developing and new types of memory media are expected. While the following embodiments are directed at SFF flash memory devices, embodiments using other types of memory media, including SFF drives such as Microdrive and future developments of SFF memory devices, are possible and are hereby included.

In the preferred embodiment, controller 330 performs one or more of the following functions to improve data integrity and memory access speeds: data striping, disk mirroring, error correction, data caching and providing parity information. The parity information may be stored on a dedicated memory device or may be distributed across more than one of memory devices in the array. Preferably, memory array management is compatible with one of the RAID levels, in particular one of RAID 0, RAID 1 and/or RAID 5.

In the preferred embodiment, encryption is performed by encryption element 340, which encrypts the stored data with an encryption data sequence, preferably upon sector access. The encryption data sequence may be predefined, generated internally, or established by the user. Controller 330 may obtain the encryption data sequence by reading the sequence itself or parameters for generating the sequence from a separate memory device, such as a subscriber identity module (SIM) card which is inserted into the memory device or an external memory device connected via a USB or a Peripheral Component Interconnect (PCI) bus. The encryption data is not stored within memory array 310, but rather in a separate encryption data memory 350. In a first preferred embodiment, encryption data memory 350 is a component of storage device 300, and preferably consists of a flash memory. In an alternate preferred embodiment, encryption data memory 350 is an external memory which is accessible to encryption element 340.

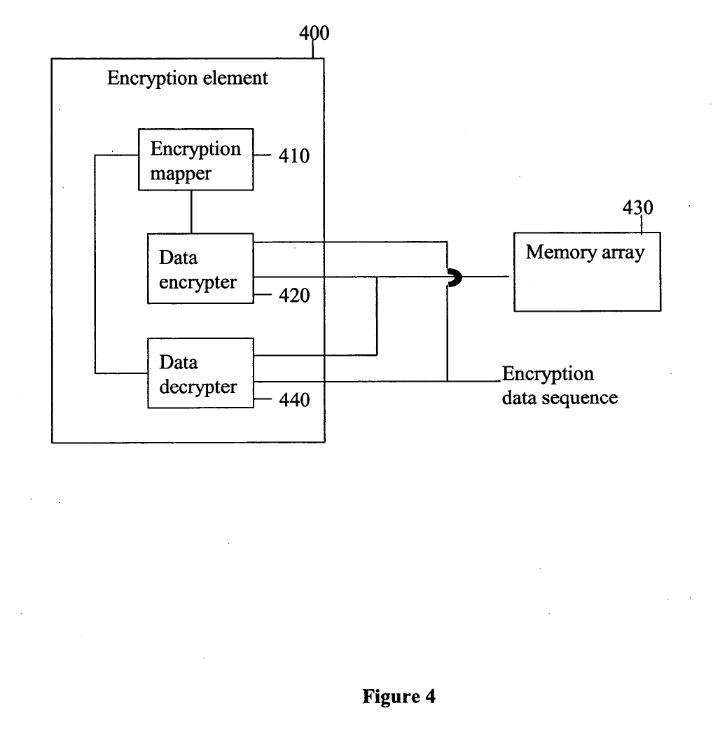

Reference is now made to FIG. 4, which is a simplified block diagram of an encryption element, according to a preferred embodiment of the present invention. Each of the memory devices making up memory array 430 is subdivided into multiple sectors, and the encryption data sequence is grouped into multiple blocks. Encryption element 400 consists of encryption mapper 410 and data encrypter 420. Encryption is based on a mapping between the memory array sectors and the encryption sequence blocks. Preferably the size of a block and a sector are essentially equal. For commonly used memory devices, the requirement that the size of a block and a sector be of comparable size yields an encryption data sequence longer than the encryption keys currently in use by many prior art encryption algorithms.

Data encryption is performed as follows. Encryption mapper 410 provides a mapping between the memory array sectors and blocks of the data encryption sequence. The mapping may be predefined, selected from a group of predefined mappings, specified by the user, or generated by encryption mapper 410. Each sector is mapped to a corresponding block of the encryption sequence. If the number of sectors exceeds the number of encryption sequence blocks, each block may be associated with multiple sectors.

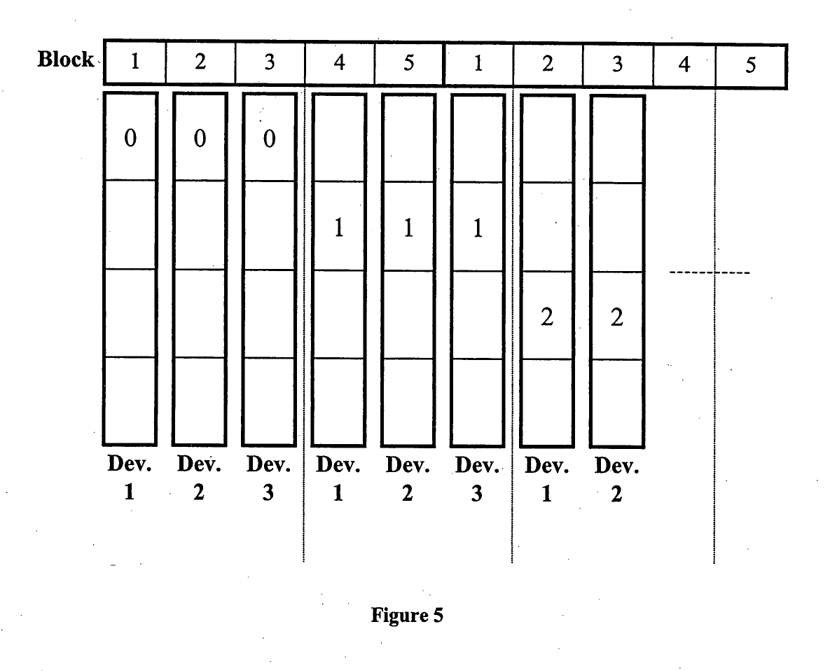

Reference is now made to FIG. 5, which shows an example of a mapping between memory sectors and encryption sequence blocks. In the current example, there are three memory devices making up the memory array, where each device has four sectors, numbered 0-3. The encryption data sequence is divided into five blocks, numbered 1-5. The number of memory devices, sectors per memory device, and number of data sequence blocks are for purposes of illustration only, and are not limiting.

As shown FIG. 5, sector 0 of device 1 is mapped to block one, sector 0 of device 2 is mapped to block 2, sector 0 of device 3 is mapped to block 3, sector 1 of device 1 is mapped to block 4, and so forth. Since the total number of sectors (in this case 12) exceeds the number of blocks, the mapping proceeds cyclically. When the final block of the encryption sequence is reached, the mapping continues at the first data sequence block. Thus only selected and non-continuous portions of the encryption sequence are used to encrypt each of the memory devices, rather than the sequence as a whole. The current encryption technique is particularly effective for RAID memory systems in which the stored data is spread out over multiple memory devices. Decryption requires knowledge of the data redundancy technique being employed, in addition to the encryption sequence, mapping, and encryption technique.

With a mapping established, data encrypter 420 encrypts the data for a given sector with the corresponding mapped block of the encryption sequence. In the preferred embodiment, sector data is encrypted by XORing the sector data with the encryption sequence block.

Preferably, encryption element 400 also contains data decrypter 440 which decrypts stored data (preferably upon sector access) with the same encryption data sequence used for encryption, and according to the established mapping. To decrypt a given sector of the memory array, data decrypter 440 establishes which block of the data encryption sequence corresponds to the given sector. Data decrypter 440 then uses the corresponding data sequence block to decrypt the data stored the sector in accordance with the encryption technique used by data encrypter 420, preferably by XORing sector data with the data sequence block.

Returning to FIG. 3, in the preferred embodiment, controller 330 erases the encryption data sequence from encryption data memory 350 when a trigger event occurs. Possible trigger events include receiving software or hardware command, unauthorized data access (i.e. user password error more than a specified number of times), or detecting that storage device 300 and/or memory array 310 are being physically opened or moved. Since knowledge of the encryption data sequence is required in order to decrypt the data stored in memory array 310, erasing the key prevents decryption by unauthorized persons. However authorized users can reconstruct the encryption data sequence, and are therefore able to decrypt the stored data, even if the encryption sequence has been erased.

In the preferred embodiment, storage device 300 also contains a data interface 360 for inputting and outputting data. Using SFF flash memories as memory devices (320.1 to 320.n) enables data interface 360 to be implemented as one of a wide spectrum of currently available interfaces. Interfaces currently in use with the various SFF flash devices include: Advanced Technology Attachment (ATA) interface, SATA interface, Universal Serial Bus (USB) interface, IEEE 1394 interface, small computer system interface (SCSI), and Ethernet interface.

Preferably, controller 330 contains control interface 370 for inputting and outputting data required to perform control and maintenance functions. Preferably the control and maintenance functions include one or more of the following functions: programming the controller, inputting an encryption data sequence or parameters for generating the data sequence, outputting an encryption data sequence, inputting a password for data access, upgrading software, diagnostic testing, selecting a redundancy method, establishing system definitions, and formatting the memory array.

The memory devices used to form the memory array may be selected according to memory capacity, access speed, and cost requirements. For example, a 12 Gbyte memory subsystem may be created using an array of twelve 1 GB CF™ cards, or from three of the smaller, more expensive 4 Gbyte CF™ cards. A higher capacity device may be based on a memory array of 12 Microdrive devices of 4 Gbyte each, yielding a small, relatively inexpensive device with a 48 GB data storage capacity.

Following is an implementation of a secured memory subsystem based on a memory array of 2-16 CF™ memory cards (type I or II) with TrueIDE functionality. The subsystem is based on FPGA IP, which is easily upgradeable. The subsystem supports RAID levels 0, 1, and 5, with SATA 2, USB 2, and 1000 Base T (iScsi or NAS) interfaces. The memory subsystem has a built-in 1 MB flash encryption data memory for storing the data encryption sequence. The system has a serial (RS232-115200BPS) maintenance connector for performing maintenance functions such as: updating security data (including the data encryption sequence), formatting the memory cards, read and writing to sectors of the memory array, and changing parameters and/or system configuration. The memory subsystem also supports replacement of bad media (in RAID 5) and hot swap.

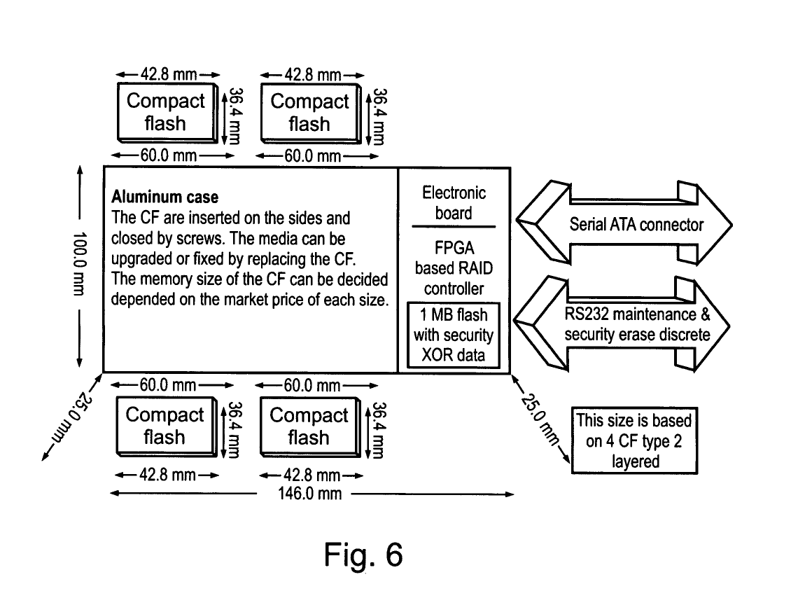

FIG. 6 illustrates an example of a hardware configuration which can contain four CF™ type 2 cards along with a controller. The dimensions of the case are the same as that of a 3.5″ disk. A similar design can be based on a 2.5″ disk size.

The secured memory subsystem described provides secured storage of sensitive material, and, due to its high capacity coupled with small physical size, is suitable for use in portable devices. For example, memory subsystem may be used in mobile computers, PDAs and cell phones which may contain user-sensitive data such as bank numbers, passwords and confidential business information. The subsystem may also be used in military equipment, with the controller set to erase the data encryption key when there are indications that the equipment may fall into hostile hands.

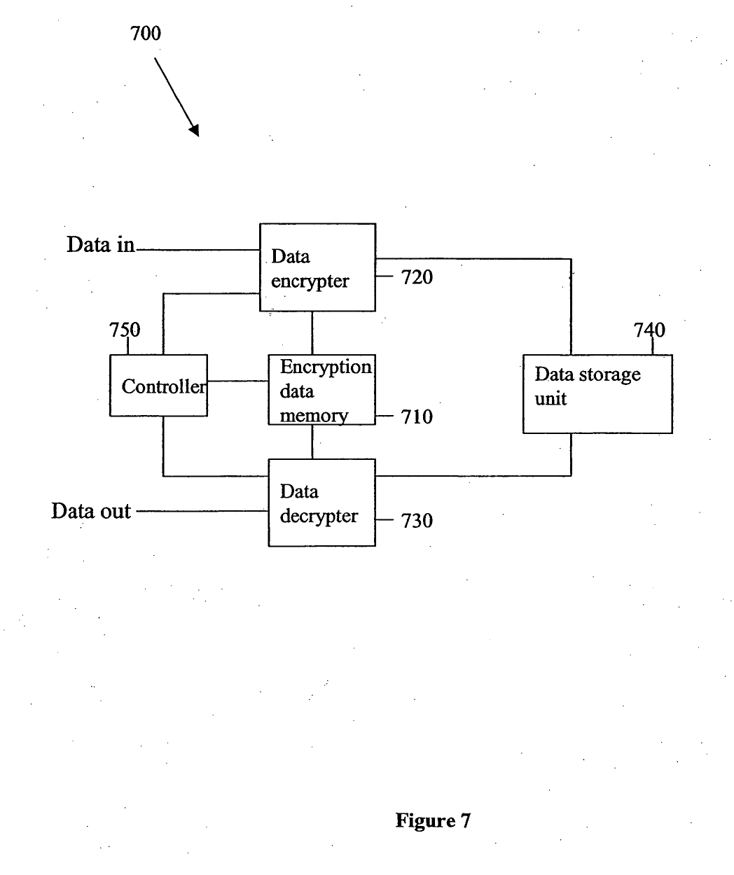

Reference is now made to FIG. 7, which is a simplified block diagram of a data securer, according to a first preferred embodiment of the present invention. Data securer 700 contains encryption data memory 710, which stores an encryption data sequence, and data encrypter 720, which encrypts data stored in a separate memory element. Preferably, encryption data memory 710 is a flash memory. Data encrypter 720 performs encryption using the encryption data sequence. Separating the encrypted data from the encryption sequence provides an extra layer of data security, as unauthorized access requires knowledge of both the key and the encryption algorithm which was used.

Preferably, data securer 700 further contains data decrypter 730 for decrypting stored data using the encryption data sequence.

Data securer 700 preferably further contains data storage unit 740 for storing the secured data. Data storage unit 740 may be a RAID memory subsystem.

In the preferred embodiment, data securer 700 contains controller 750 which manages data security, by performing functions such as generating the encryption sequence or receiving an externally generated encryption sequence, storing the sequence in encryption data memory 710, erasing the data sequence from encryption data memory 710

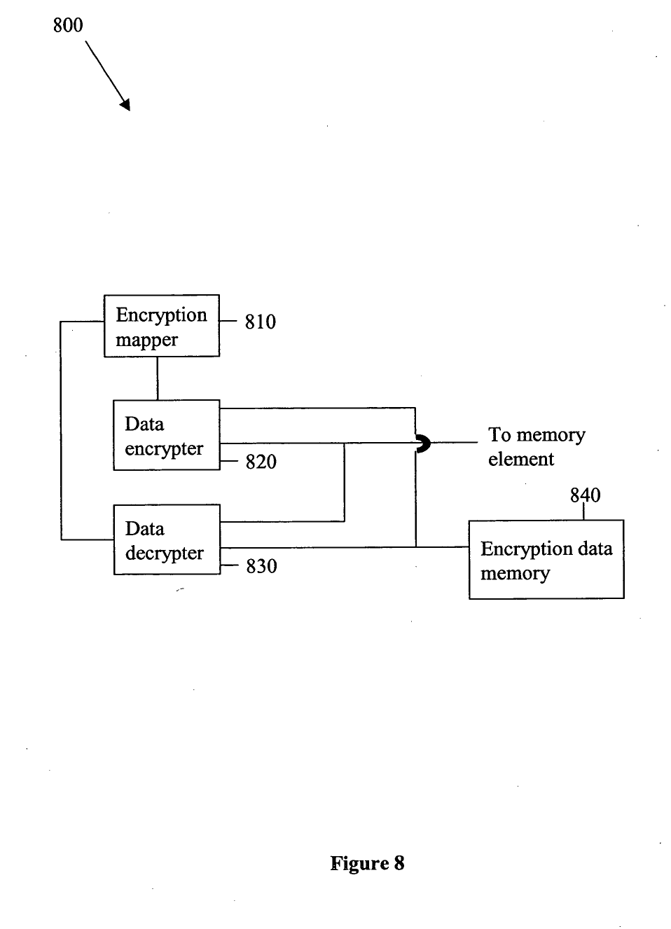

Reference is now made to FIG. 8, which is a simplified block diagram of a data securer, according to a second preferred embodiment of the present invention. Data securer 800 encrypts data which is stored in a memory device subdivided into multiple sectors, using an encryption data sequence which is grouped into multiple blocks. The data securer consists of encryption mapper 810, which maps each of the sectors to one of the blocks, and data encrypter 820, which encrypts sector data using the corresponding block of the encryption data sequence. Preferably the size of a block and a sector are essentially equal. As discussed above, the minimum length of the resulting encryption data sequence is two or more times the size of a memory sector. In the preferred embodiment, data securer 800 further contains data decrypter 830, for decrypting stored data using the corresponding block of the encryption data sequence. Preferably, data securer 800 also contains encryption data memory 840 for storing the encryption data sequence.

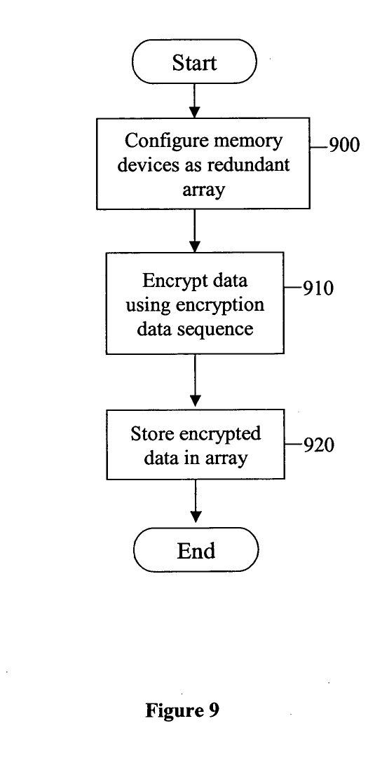

Reference is now made to FIG. 9, which is a simplified flowchart of a method for securing stored data, according to a first preferred embodiment of the present invention. In step 900, a plurality of solid state memory devices are configured as a redundant array, such as a RAID memory. In step 910, sector data is encrypted with an encryption data sequence, where the encryption data sequence is stored outside the memory array, on a separate memory element. Sector data includes data received for storage in a given sector and/or data already stored in the sector. Preferably, the method further includes step 920, in which the encrypted data is stored in the memory array.

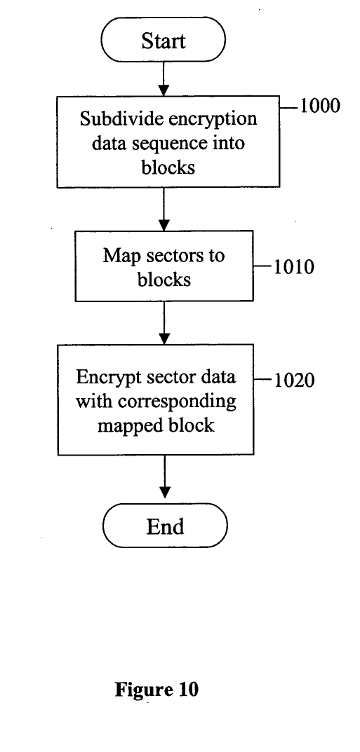

Reference is now made to FIG. 10, which is a simplified flowchart of a method for encrypting data with an encryption data sequence, according to a preferred embodiment of the present invention. The data being encrypted is associated with a specified sector of a data memory. The data may be currently stored in the specified sector of the array or may be destined for storage in the specified sector. Preferably the encryption is performed upon sector access.

In a first preferred embodiment the data memory is a redundant array of memory devices, as described for FIG. 9 above, where each of the memory devices is subdivided into multiple sectors. In a second preferred embodiment the data memory is a single memory device which is subdivided into multiple sectors.

In step 1000 the encryption data sequence is subdivided into multiple blocks. Preferably, the size of the blocks essentially equals the size of a memory sector. Each of the sectors of the memory device is mapped to a corresponding encryption sequence block in step 1010. In step 1020, the data associated with a specified sector is encrypted with the encryption sequence block to which it was mapped in step 1010. Note that step 1020 may be performed repetitively to encrypt data for multiple sectors. For example, all currently stored data may be re-encrypted when a new encryption data sequence is selected. The method may include the further step of decrypting data stored in a specified sector(s) with the corresponding mapped block(s) of the encryption data sequence.

Preferably, encrypting (and decrypting) consists of XORing the sector data with the corresponding mapped block of the encryption data sequence.

Preferably the method contains the further step of outputting the decrypted data.

Preferably the method contains the further step of inputting the encryption data sequence and/or storing the encryption data sequence in an encryption sequence memory.

Preferably the method contains the further step of erasing the encryption data sequence upon occurrence of a trigger event.

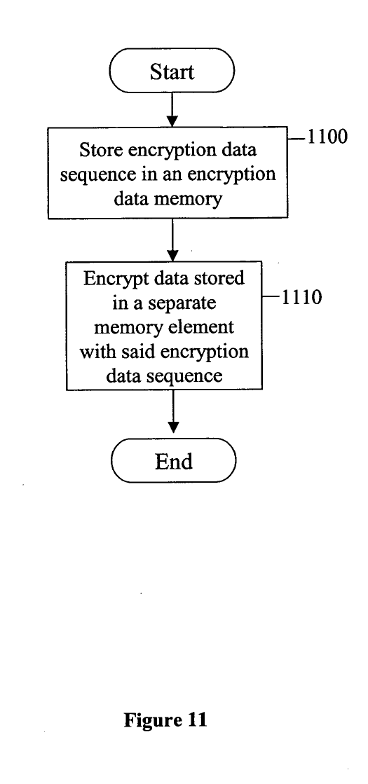

Reference is now made to FIG. 11, which is a simplified flowchart of a method for securing stored data, according to a second preferred embodiment of the present invention. In step 1100 an encryption data sequence is stored in an encryption data memory. In step 1110 data stored (or destined for storage) in a separate memory device is encrypted using the encryption data sequence.

In the preferred embodiment, encryption is performed by XORing the data with the encryption data sequence in accordance with a predefined mapping. The mapping may be based on mapping memory sectors to data sequence blocks, as described above.

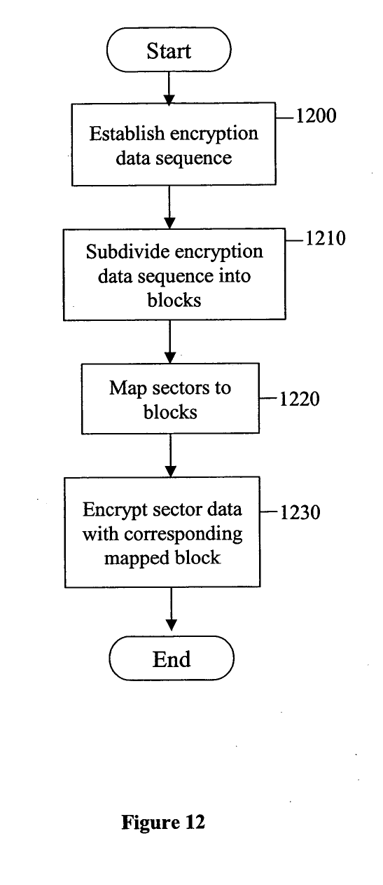

Reference is now made to FIG. 12, which is a simplified flowchart of a method for securing stored data, according to a third preferred embodiment of the present invention. The data is stored in a memory element subdivided into multiple sectors. The memory element may be a single memory device, a simple array of memory devices, or a redundant array of memory devices. In step 1200, an encryption data sequence is established. The encryption data sequence is subdivided into multiple blocks in step 1210, where the size of a block essentially equals the size of a memory element sector. In step, 1220, each of the memory element sectors is mapped to a corresponding block of the encryption data sequence, and in step 1230 data is encrypted in a specified sector using the corresponding block of the encryption data sequence.

The increasing prevalence of portable electronic equipment in both the consumer and military arenas has caused a corresponding increase in the demand for small, high capacity secure memories. Flash, and other non-volatile memory technologies, are developing as well, but are not keeping pace with the increasingly stringent technical requirements. The abovedescribed embodiments provide a way to combine existing memory devices, in particular small form factor devices with low power requirements and advanced interfacing technologies, to create a memory subsystem for encrypted data storage with smaller size and improved accessibility. The secured memory subsystems presented above are easily upgradeable by replacing the memory devices forming the redundant array or by installing additional memory devices.

The abovedescribed embodiments can be used for data storage and security in a wide variety of consumer equipment, such as digital cameras, pagers, audio recorders, mobile phones, PDAs, mobile computers, and wearable belt-size computers. The present embodiments can also be used to provide data security in airborne and ground military systems.

It is expected that during the life of this patent many relevant memory devices, solid state memories, SFF memories, flash memories, encryption techniques, redundant memory configurations, and portable devices will be developed and the scope of the term memory device, solid state memory, SFF memory, flash memory, encryption technique, redundant memory configuration, and portable device is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A storage device, comprising:
a plurality of solid state memory devices configured as a redundant array, and
a memory controller associated with said memory array, for performing data encryption to provide secured access to said array.

2. A storage device according to claim 1, wherein said controller comprises an encryption element for encrypting data with an encryption data sequence stored on a memory element external to said array.

3. A storage device according to claim 2, wherein said encrypting is performed upon sector access.

4. A storage device according to claim 2, wherein each of said memory devices is subdivided into multiple sectors, and wherein said encryption data sequence is grouped into multiple blocks, said encryption element comprising:
an encryption mapper, for mapping each of said sectors to one of said blocks; and
a data encrypter associated with said encryption mapper, for encrypting data associated with a first specified sector with a corresponding mapped block of said encryption data sequence.

5. A storage device according to claim 4, wherein the size of a block and the size of a sector are essentially equal.

6. A storage device according to claim 4, wherein said encrypting comprises XORing said data associated with said first specified sector with a corresponding mapped block of said encryption data sequence.

7. A storage device according to claim 4, wherein said encryption element further comprises a data decrypter for decrypting stored data from a second specified sector with a corresponding mapped block of said encryption data sequence.

8. A storage device according to claim 7, wherein said decrypting comprises XORing data stored in said second specified sector with said corresponding block of said encryption data sequence.

9. A storage device according to claim 1, wherein said controller comprises an encryption data memory for storing said encryption data sequence.

10. A storage device according to claim 9, wherein said encryption data memory comprises a flash memory.

11. A storage device according to claim 4, wherein said mapping is cyclic.

12. A storage device according to claim 2, wherein said encrypting comprises XORing said data with said encryption data sequence in accordance with a predefined mapping.

13. A storage device according to claim 2, wherein said controller is operable to erase said encryption data sequence upon occurrence of a trigger event.

14. A storage device according to claim 13, wherein said trigger event comprises receipt of an external trigger signal.

15. A storage device according to claim 13, wherein said trigger event comprises receiving an incorrect password for data access.

16. A storage device according to claim 2, wherein said encryption data sequence is provided externally.

17. A storage device according to claim 2, wherein said controller comprises an encryption generator for generating said encryption data sequence.

18. A storage device according to claim 1, wherein said memory devices comprise flash memories.

19. A storage device according to claim 1, wherein said memory devices comprise small form factor memories.

20. A storage device according to claim 18, wherein said memory devices comprise small form factor memories.

21. A storage device according to claim 20, wherein said memory devices comprise one of a group of devices comprising: CompactFlash (CF™), Multimedia Card (MMC), Secure Digital (SD), Memory stick, Smart Media, and xD Picture Card.

22. A storage device according to claim 1, wherein said redundancy is in accordance with a Redundant Array of Independent Disks (RAID) standard.

23. A storage device according to claim 1, wherein said controller is operable to provide data striping.

24. A storage device according to claim 1, wherein said controller is operable to provide disk mirroring.

25. A storage device according to claim 1, wherein said controller is operable to provide parity information.

26. A storage device according to claim 25, wherein said parity information is stored on a dedicated one of said memory devices.

27. A storage device according to claim 25, wherein said parity information is distributed across more than one memory device.

28. A storage device according to claim 1, wherein said controller is operable to provide error correction.

29. A storage device according to claim 1, wherein said controller is operable to provide data caching.

30. A storage device according to claim 1, wherein said controller comprises a field programmable gate array (FGPA).

31. A storage device according to claim 1, further comprising a data interface for inputting data and outputting data.

32. A storage device according to claim 31, wherein said data interface comprises an Advanced Technology Attachment (ATA) interface.

33. A storage device according to claim 31, wherein said data interface comprises a serial ATA (SATA) interface.

34. A storage device according to claim 31, wherein said data interface comprises a Universal Serial Bus (USB) interface.

35. A storage device according to claim 31, wherein said data interface comprises an IEEE 1394 interface.

36. A storage device according to claim 31, wherein said data interface comprises a small computer system interface (SCSI).

37. A storage device according to claim 31, wherein said data interface comprises an Ethernet interface.

38. A storage device according to claim 1, wherein said controller comprises a control interface for inputting and outputting control data.

39. A storage device according to claim 38, wherein said control data is for performing at least one of a group of functions comprising: programming said controller, inputting an encryption data sequence, inputting encryption data sequence parameters, outputting an encryption data sequence, inputting a password, upgrading software, diagnostic testing, selecting a redundancy method, establishing system definitions, and formatting said memory array.

40. A data securer, for securing stored data, comprising:
an encryption data memory, for storing an encryption data sequence; and
a data encrypter, for encrypting data stored in a separate memory element using said encryption data sequence.

41. A data securer according to claim 40, wherein said memory element is external.

42. A data securer according to claim 40, further comprising a data storage unit for storing encrypted data.

43. A data securer according to claim 40, wherein said data storage unit comprises a RAID memory.

44. A data securer according to claim 40, wherein said encrypting comprises XORing stored data with said encryption data sequence in accordance with a predefined mapping.

45. A data securer according to claim 40, further comprising a data decrypter for decrypting stored data using said encryption data sequence.

46. A data securer according to claim 45, wherein said decrypting comprises XORing stored data with said encryption data sequence in accordance with a predefined mapping.

47. A data securer according to claim 40, further comprising a controller for managing data security.

48. A data securer according to claim 40, wherein said controller is operable to erase said encryption data sequence upon occurrence of a trigger event.

49. A data securer according to claim 48, wherein said trigger event comprises receipt of an external trigger signal.

50. A data securer according to claim 40, wherein said encryption data sequence is provided externally.

51. A data securer according to claim 47, wherein said controller comprises an encryption generator for generating said encryption data sequence.

52. A data securer according to claim 40, wherein said encryption data memory comprises a flash memory.

53. A data securer, for securing data with an encryption data sequence, said data being stored in a memory element subdivided into multiple sectors, and said encryption data sequence being grouped into multiple blocks, comprising:
an encryption mapper, for mapping each of said sectors to one of said blocks; and
a data encrypter, for encrypting data associated with a first specified sector with a corresponding mapped block of said encryption data sequence.

54. A data securer according to claim 53, wherein the size of a block and the size of a sector are essentially equal.

55. A data securer according to claim 53, further comprising a data decrypter for decrypting stored data from a second specified sector with a corresponding mapped block of said encryption data sequence.

56. A data securer according to claim 53, wherein said encrypting comprises XORing said associated data with said corresponding mapped block of said encryption data sequence.

57. A data securer according to claim 55, wherein said decrypting comprises XORing data stored in said second specified sector with said corresponding block of said encryption data sequence.

58. A data securer according to claim 53, further comprising an encryption data memory for storing said encryption data sequence.

59. A method for securing stored data, comprising:
configuring a plurality of solid state memory devices as a redundant array, and
encrypting data for storage on said array with an encryption data sequence stored on a memory element external to said array.

60. A method for securing stored data to claim 59, further comprising storing said encrypted data in said array.

61. A method for securing stored data to claim 59, wherein each of said memory devices is subdivided into multiple sectors, said encrypting comprising:
subdividing said encryption data sequence into multiple blocks;
mapping each of said sectors to a corresponding one of said blocks; and
encrypting data associated with a first specified sector with said corresponding mapped block of said encryption data sequence.

62. A method for securing stored data to claim 61, wherein the size of a block and the size of a sector are essentially equal.

63. A method for securing stored data to claim 61, wherein said encrypting comprises XORing said associated data with said corresponding mapped block of said encryption data sequence.

64. A method for securing stored data to claim 61, further comprising decrypting data stored in a second specified sector with a corresponding mapped block of said encryption data sequence.

65. A method for securing stored data to claim 59, further comprising outputting said decrypted data.

66. A method for securing stored data to claim 64, wherein said decrypting comprises XORing data stored in said sector with said corresponding mapped block of said encryption data sequence.

67. A method for securing stored data to claim 59, further comprising inputting said encryption data sequence.

68. A method for securing stored data to claim 59, further comprising storing said encryption data sequence in an encryption sequence memory.

69. A method for securing stored data to claim 60, further comprising erasing said encryption data sequence upon occurrence of a trigger event.

70. A method for securing stored data to claim 59, wherein said redundancy is in accordance with a Redundant Array of Independent Disks (RAID) standard.

71. A method for securing stored data, comprising:
storing an encryption data sequence in an encryption data memory, and
encrypting data associated with a separate memory device using said encryption data sequence.

72. A method for securing stored data, according to claim 71, wherein said memory element is subdivided into multiple sectors, said encrypting comprising:
subdividing said encryption data sequence into multiple blocks;
mapping each of said sectors to a corresponding one of said blocks; and
encrypting data associated with a first specified sector with said corresponding block of said encryption data sequence.

73. A method for securing stored data to claim 72, wherein the size of a block and the size of a sector are essentially equal.

74. A method for securing stored data, according to claim 71, said encrypting comprises XORing stored data with said encryption data sequence in accordance with a predefined mapping.

75. A method for securing stored data to claim 72, further comprising decrypting data stored in a second specified sector with a corresponding mapped block of said encryption data sequence.

76. A method for securing stored data, according to claim 71, further comprising erasing said encryption data sequence upon occurrence of a trigger event.

77. A method for securing stored data, according to claim 71, further comprising generating said encryption data sequence.

78. A method for securing stored data, according to claim 71, further comprising generating said mapping.

79. A method for securing stored data, said data being stored in a memory element subdivided into multiple sectors, comprising:
providing an encryption data sequence;
subdividing said encryption data sequence into multiple blocks wherein the size of a block and the size of a sector are essentially equal;
mapping each of said sectors to a corresponding one of said blocks; and
encrypting data associated with a first specified sector with said corresponding block of said encryption data sequence.

80. A method for securing stored data according to claim 79, further comprising decrypting stored data from a second specified sector with a corresponding block of said encryption data sequence.

81. A method for securing stored data according to claim 79, wherein said encrypting comprises XORing said associated data with said corresponding block of said encryption data sequence.

82. A method for securing stored data according to claim 80, wherein said decrypting comprises XORing data stored in said second specified sector with said corresponding block of said encryption data sequence.
